(19) United States
(12) Patent Application Publication
(10) Pub. No.: US 2024/0020146 A1
(43) Pub. Date: Jan. 18, 2024

(54) CONTAINER VISIBILITY AND OBSERVABILITY

(71) Applicant: VMWARE, INC., Palo Alto, CA (US)

(72) Inventors: SHIRISH VIJAYVARGIYA, Pune (IN); SUNIL HASBE, Pune (IN)

(21) Appl. No.: 17/950,132

(22) Filed: Sep. 22, 2022

(30) Foreign Application Priority Data
Jul. 14, 2022 (IN) 202241040486

(51) Int. Cl. G06F 9/455

(52) U.S. Cl. CPC G06F 9/45558; G06F 2009/45591; G06F 2009/45595; G06F 2009/45575; G06F 2009/45587

(57) ABSTRACT

Computer-implemented methods, media, and systems for providing container visibility and observability are disclosed. In one computer-implemented method, a host device connected to a cloud server detects a plurality of events comprising a first event, wherein the host device hosts a plurality of containers that generate the plurality of events. The host device identifies a first container identifier of the first event, checks a container tracking database to determine if the container tracking database includes the first container identifier. In response to determining that the container tracking database does not include the first container identifier, the host device creates a container start event indicating a start of a first container identified by the first container identifier, and sends the container start event to the cloud server for providing a container inventory that reflects statuses of the plurality of events and the plurality of containers in the host device.

### RELATED APPLICATIONS

Benefit is claimed under 35 U.S.C. 119(a)-(d) to Foreign Application Serial No. 202241040486 filed in India entitled “CONTAINER VISIBILITY AND OBSERVABILITY”, on Jul. 14, 2022, by VMware, Inc., which is herein incorporated in its entirety by reference for all purposes

The present application (Attorney Docket No. I178.01) is related in subject matter to U.S. Patent Application No. ______ (Attorney Docket No. I178.02), which is incorporated herein by reference.

### TECHNICAL FIELD

The present disclosure relates to computer-implemented methods, media, and systems for providing container visibility, observability and security manageability.

### BACKGROUND

Containerization approaches have been adopted, for example, by enterprises to manage and run server workloads on Linux servers. Customers may have different container environments, including but not limited to Kubernetes, Amazon® Elastic Compute Cloud (ECS), and Docker. A large number of workloads can be run on various different types of container hosts. Currently, customers do not have visibility of container workloads and the runtime environment they are running on. It is desirable to provide visibility, observability and security manageability of containers to the customers so that they can have a better understanding of containers running in their environment.

### SUMMARY

The present disclosure involves computer-implemented method, medium, and system for providing container visibility, observability and security manageability. One example of a computer-implemented method includes detecting, by a host device connected to a cloud server, a plurality of events comprising a first event, wherein the host device hosts a plurality of containers that generate the plurality of events; identifying, by the host device, a first container identifier of the first event; checking, by the host device, a container tracking database to determine if the container tracking database includes the first container identifier; in response to determining that the container tracking database does not include the first container identifier, creating, by the host device, a container start event indicating a start of a first container identified by the first container identifier; and sending, by the host device, the container start event to the cloud server for providing a container inventory that reflects statuses of the plurality of events and the plurality of containers in the host device.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a schematic diagram illustrating an example computing system or environment that can execute implementations of the present disclosure.

FIG. 2 is a schematic diagram illustrating an example computing system or environment that can execute implementations of the present disclosure.

FIG. 3 is a schematic diagram illustrating an example flow for creating container events, in accordance with example implementations of this specification.

FIG. 4 is a flowchart illustrating an example method for providing container visibility and observability, in accordance with example implementations of this specification.

FIG. 5 is a flowchart illustrating an example method for providing container security manageability, in accordance with example implementations of this specification.

FIG. 6 is a schematic diagram illustrating an example computing system that can be used to execute implementations of the present disclosure.

### DETAILED DESCRIPTION

This disclosure provides systems, methods, devices, and non-transitory, computer-readable storage media for providing container visibility, observability and security manageability. In some implementations, the described techniques can be used in container security space (e.g., VMware Carbon Black Cloud™ (CBC) platform) to provide improved security manageability. In some implementations, the described techniques can help build a container inventory, for example, on a cloud console or server, to help users (e.g., operators) visualize and relate events with containers. In some implementations, the described techniques can be used to implement runtime security on Linux hosts with container awareness. In some implementations, the described techniques can provide container context information to users in one or more user interfaces (UIs), for example, by embedding container context in a UI dashboard, to improve container security management and visibility. Visibility and security for containers, like other workloads in the system, can facilitate correlating events between workloads to understand a wider picture of an application context, allow more flexibility in customization, and facilitate meeting business demands.

In some implementations, to build a container inventory at the cloud side, one solution is to integrate the cloud security system (e.g., the CBC platform) with a container orchestration layer such as Kubernetes. However, this approach requires additional configuration and authentication overheads and requires multiple involvements of administrators. In some implementations, not all the containers deployed in an organization necessarily have an orchestration layer or the same orchestration layer. In some implementations, customers have different container environments, not just Kubernetes. For example, there can be multiple types of containers such as CRIO, CONTAINERD, and DOCKER deployed at the customer site. The described techniques can address these issues and provide a container technology agnostic solution.

The described techniques can support different containers runtimes, with or without an orchestration layer such as Kubernetes (k8s). In some implementations, the described techniques can provide users a broader understanding of workload security. For example, in case the orchestrator is Kubernetes, the described techniques can allow the users to connect the dots between the container to its part of workload (deployment, replica, deamonset, etc.)

In some implementations, the described techniques can leverage a Linux sensor to enhance runtime security capabilities and add a containerization layer to the overall workload security offering. In some implementations, the sensor is configured to report events happening inside containers to the cloud server without putting any sensor inside containers. In some implementations, the sensor is further configured to generate container life cycle management (LCM) events (e.g., a container start event, a container discovery event, and a container stop event) and report the container LCM events for creating a container inventory and perform security analysis. The container LCM events can be visualized at a UI dashboard. In some implementations, the container LCM events can be classified based on containers. Accordingly, users can benefit from a better understanding of containers running in their environment. The described techniques allows the users to isolate container events based on certain container attribute and to relate events with containers.

The described techniques can save the additional configuration and management overhead, do not limit the cloud sever to deal with a specific container technology, and save the cost of building multiple event sources for multiple container technologies. In some implementations, the described techniques can provide a lightweight and container technology/management layer agnostic solution to simply container visibility and security manageability. In some implementations, the described techniques can achieve additional or different technical advantages.

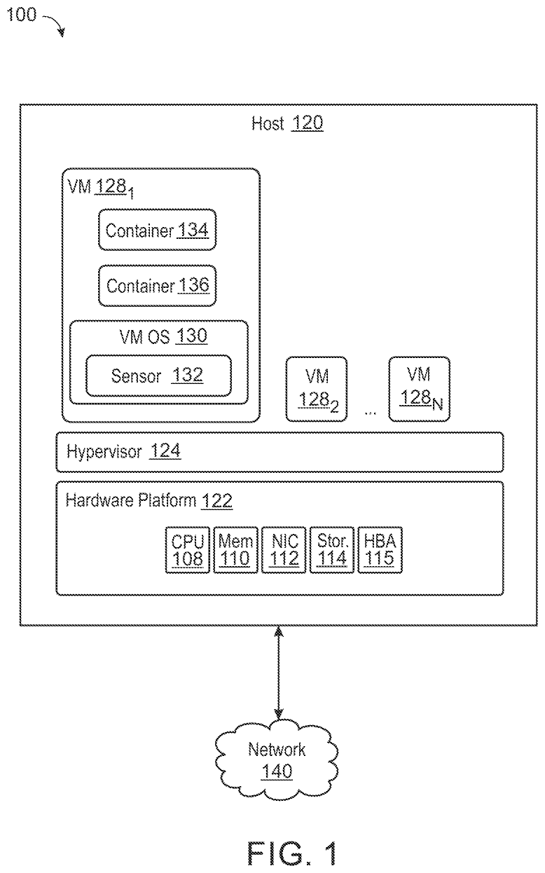

FIG. 1 is a schematic diagram illustrating an example computing system or computing environment 100 that can execute implementations of the present disclosure. As shown, computing system 100 includes a host device (or host) 120 connected to a network 140. The host can be an endpoint device, for example, in a cloud network or platform (e.g., VMware Carbon Black Cloud™ (CBC)). Network 140 may, for example, be a local area network (LAN), wide area network (WAN), cellular data network, the Internet, or any connection over which data may be transmitted.

Host 120 is configured with a virtualization layer, referred to herein as hypervisor 124, that abstracts processor, memory, storage, and networking resources of hardware platform 122 into multiple virtual machines (VMs) 128₁ to 128_{N} (collectively referred to as VMs 128 and individually referred to as VM 128). VMs on the same host 120 may use any suitable overlaying guest operating system(s), such as guest OS or VM OS 130, and run concurrently with the other VMs.

Hypervisor 124 architecture may vary. In some aspects, hypervisor 124 can be installed as system level software directly on the hosts 120 (often referred to as a “bare metal” installation) and be conceptually interposed between the physical hardware and the guest operating systems executing in the VMs. Alternatively, hypervisor 124 may conceptually run “on top of” a conventional host operating system in the server. In some implementations, hypervisor 124 may comprise system level software as well as a privileged VM machine (not shown) that has access to the physical hardware resources of the host 120. In such implementations, a virtual switch, virtual tunnel endpoint (VTEP), etc., along with hardware drivers, may reside in the privileged VM. The hypervisor 124 can be, for example, VMware Elastic Sky X Integrated (ESXi).

Hardware platform 122 of host 120 includes components of a computing device such as one or more of a processor (e.g., CPU) 108, a system memory 110, a network interface 112, a storage system 114, a host bus adapter (HBA) 115, or other I/O devices such as, for example, a USB interface (not shown). CPU 108 is configured to execute instructions such as executable instructions that perform one or more operations described herein. The executable instructions may be stored in memory 110 and in storage 114. Network interface 112 enables host 120 to communicate with other devices via a communication medium, such as network 140. Network interface 112 may include one or more network adapters or ports, also referred to as Network Interface Cards (NICs), for connecting to one or more physical networks.

The example VM 128₁ comprises containers 134 and 136 and a guest OS 130. Each of containers 134 and 136 generally represents a nested virtualized computing instance within VM 128₁. Implementing containers on virtual machines allows for response time to be improved as booting a container is generally faster than booting a VM. In some implementations, all containers in a VM run on a common OS kernel, thereby fully utilizing and sharing CPU, memory, I/O controller, and network bandwidth of the host VM. Containers also have smaller footprints than VMs, thus improving density. Storage space can also be saved, as the container uses a mounted shared file system on the host kernel, and does not create duplicate system files from the parent OS.

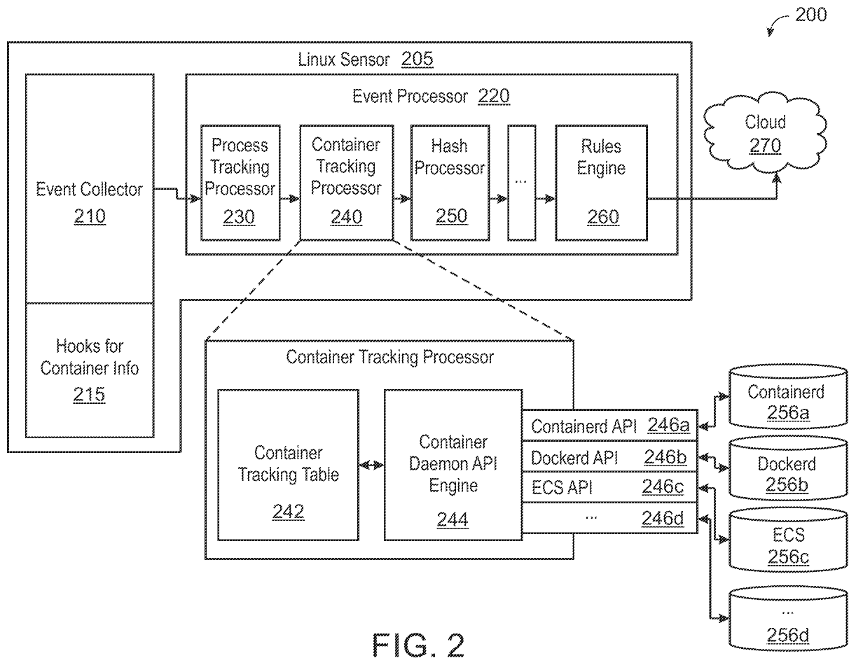

VM 128₁ further comprises a guest OS 130 (e.g., Linux™ , Microsoft Windows®, or another commodity operating system) and an agent or sensor 132. The sensor can run on top of guest OS 130. Sensor 132 represents a component that can provide visibility, observability and security manageability of the containers (e.g., containers 134 and 136) running in the VM 128₁. For example, sensor 132 can generate one or more a container LCM events (e.g., a container start event, a container discovery event, and a container stop event) and report the container LCM events for container inventory and security analytics, as described in more detail below with respect to FIGS. 2-5.

FIG. 2 is a schematic diagram illustrating another example computing system or environment 200 that can execute implementations of the present disclosure. FIG. 2 shows an example implementation of a security solution that can be implemented by the computing system 100 in FIG. 1. As shown, computing system 200 includes a sensor (e.g., a CBC Linux sensor) 205 and a cloud server 270 (e.g., a CBC server). The sensor 205 includes an event collector 210 (e.g., a Berkeley Packet Filter (BPF) collector) and an event processor 220. In some implementations, the sensor 205 is on an endpoint or VM side (e.g., in a host device such as the host 120 in FIG. 1), while the cloud server 270 can be on a remote side or a cloud backend side.

The event collector 210 includes or is configured with hooks 215 for capture events in the endpoint or host device. The hooks 215 can include hooks and/or extended BPF (eBPF) probes that can capture container information such as cgroup, namespace, etc.

The event processor 220 includes various components for implementing an event pipeline with multiple stages, each of which augments the event with additional contextual information. In some implementations, the event processor 220 includes a process tracking processor 230, a container tracking processor 240, a hash processor 250, and a rules engine 260. In some implementations, the hash processor 250 is configured to compute a hash (e.g., a SHA256 checksum) of a file or process. In some implementations, the final stage of this pipeline is the rules engine 260 such as a Dynamic Rules Engine (DRE), which sources its MatchData values from the data collected from the earlier stages of the event pipeline in order to evaluate the event against all the provided rules. The MatchData can be a data rule template, which is used to match rule data with the data collected in the various pipeline stages.

The process tracking processor 230 and the container tracking processor 240 can be used for implementing a container tracking stage in the event pipeline. When a new event appears to be running in a container context based on the low level information such as cgroup, the container tracking stage (e.g., implemented by the container tracking processor 230) can be responsible for querying a container daemon that spawned the container event. The container tracking processor 230 can then store and track that container information in a table (e.g., a container tracking table 242) that is accessible to the rules engine 260 (e.g., DRE) via MatchData callbacks.

In some implementations, the sensor 205 uses various hooks/eBPF probes 215 to capture raw events. The hooks/eBPF probes 215 can be used to capture container information such as cgroup, namespace, etc. Containers are processes running in a common set of Linux namespaces, which are often combined and managed together within a cgroup. In some implementations, every process running in the container has a cgroup field set in the kernel data structure. In some implementations, the sensor 205 can extract the cgroup for each captured event and set a field (e.g., referred to as a cgroup field) in the event to store cgroup information before putting that raw event into the event pipeline.

The event processor 220 includes various processors in the event pipeline to process each captured raw event and populate appropriate fields in the event. In some implementations, the container tracking processor 240 is added to the event pipeline to implement functions such as fetch cgroup information embedded in the raw event; based on cgroup information, invoking appropriate container APIs to collect container context, enriching the event with container context before returning the event to the next processor in the event pipeline; caching the collected information in the container tracking table 242; and creating or generating a container start event, a container stop event, or a container discovered event. Such an event is also referred to as a handcrafted or created container event because it is generated by the sensor with added container information and is not a raw event captured in the host device.

In some implementations, to collect container related attributes for event reporting, the container tracking processor 240 can interact with container engines 256a-d, such as, CONTAINERD 256a, DOCKERED 256b, and ECS 256c using a container daemon API engine 244. In some implementations, the interaction can be implemented using, for example, OCI hooks, container specific event channels, and container engine specific APIs (e.g., container engine specific APIs 246a-d). For example, OCI hooks are configured with JSON files (ending with a .json extension) in a series of hook directories and would require additional configuration overhead. As another example, container engines such as CONTAINERD and DOCKER provide subscription based event channels. After the subscription, the subscribed thread/process gets events as and when any event happens inside the container. In some implementations, the container engine specific API can be selected to collect information from the container engines. Example advantage of using the container engine specific API can include (1) this is an uniform approach because all supported container engines provide APIs; (2) to collect container related information over the API, only for the first event of every started container needs to be captured and collected. In some implementations, the collected information can be cached in a container tracking table 242; (3) given that already hooks have been included in the sensor 205 to capture activities irrespective of whether the activities are happening within a container or host, the existing event pipeline can be re-used for container specific events as well; (4) using the container engine specific API can save configuration overhead that would incur if the OCI hooks are used, and (5) using the container engine specific API does not require subscription as would by the container specific event channels. As an example shown in FIG. 2, the container tracking processor 240 can interact with the container engines, CONTAINERD 256a, DOCKERED 256b, and ECS 256c through respective APIs, CONTAINERD API 246a, DOCKERED API 246b, and ECS API 246c.

In some implementations, the container tracking table 242 can be used to cache extracted container attributes/data from container engines 256a-d using appropriate container APIs 246a-d. The container tracking table 242 can be used for determining container start and stop events. In some implementations, the container tracking table 242 can also be used to associate appropriate container context with the events originated from the process running inside the container. In some implementations, the container tracking table 242 can act as a cache for storing required container attributes and information. In some implementations, the container tracking table 242 can be referred by the container tracking processor 240 (an event pipeline processor) to determine start and stop of a container. The container tracking table 242 can be used by the container tracking processor 240 to associate appropriate container context with the events. In some implementations, the container tracking table 242 can contain data about running containers only.

In some implementations, the sensor 205 reports events such as filemode, netconn, childproc, etc. to the cloud server 270. These event types can be augmented with container information if these are originated from processes running inside containers. Apart from these, new event types can be introduced to report container LCM (Life Cycle Management) events (e.g., a container start/stop/discover event).

In some implementations, the example computing system or environment 200 can also include a container inventory processor, a container inventory database, and a container inventory API service. The container inventory database can be responsible for persisting the container inventory details, which can be consumed by an inventory processor and container API service. The container inventory processor can be responsible for processing and persisting the container LCM events in the inventory database. While processing container LCM events based on certain logic, full sync, delta sync, and purge workflows can be triggered. The container inventory API service can be responsible for exposing the REST endpoints which will be primarily consumed by the UI. The container inventory API service can share the database with a container inventory service. Predominantly, the container inventory API service provides read access to the container inventory data.

In some implementations, the event collector component of the sensor 205 (e.g., the event collector 210) installs various hooks 215 to capture events. Through the hooks 215, the event collector module captures events. The event collector will now add cgroup information with all captured events. All collected events are processed through various stages of the event pipeline.

In some implementations, the container tracking processor 240 of the event pipeline can process container events. An example container event processing workflow can include: (1) extract cgroup information from an event under processing; (2) check the container tracking table if there is an entry for this cgroup, that is, if the container is already running; (3) if an entry is found, then fill container related information such as container unique id from the container tracking table into the container related field of the event and return the event to the next stage of the event pipeline; (4) if no entry is found, container start or container stop event reporting workflow can be executed depending upon the event type (e.g., an exit event or any other event), then return the event to the next stage of the event pipeline.

In some implementations, on the backend, one or more of the following operations can be performed by the cloud server 270 after receiving the container context enriched events. The whole event along with augmented container details can be persist, for example, by Lucene Cloud microservice using enhanced DRE protocol buffers (protobuf). New container filter capabilities can be added to the existing search and filter facet APIs. A user interface (UI) can also be enhanced to address new filter facets and displaying container details pertaining to the container events.

In some implementations, once the sensor 205 detects the container on the host device or endpoint, it can send container LCM events to the cloud over a Unix Domain Socket (UDS) stream. These events will be pushed to container LCM streams with the help of dispatcher service. Then these events can be consumed by a container inventory service.

In some implementations, there can be three container LCM event reporting workflows: a container start event reporting workflow (also referred to as a container start event workflow), a container discover event reporting workflow (also referred to as a container discover workflow), and a container stop event reporting workflow (also referred to as a container stop event workflow). The start event reporting workflow is used for generating and sending a container start event. The discover event reporting workflow is used for generating and sending a container discover event. The stop event reporting workflow is used for generating and sending a container stop event.

An example start event reporting workflow is described as below. In some implementations, when a container is started, the following sequence of events typically happens inside a host kernel: a process of the container is forked; the process gets attached to a specific cgroup created for the container; the process calls exec( )system call to load the image of the base process/entry process of the container.

In some implementations, an event collector component of the sensor 205 (e.g., the event collector 210) captures events and fetch cgroup information for the captured event from kernel data structure and associate the cgroup information with each captured event. If a container is started and a container entry process (e.g., the base process or the first container process) will also get started. The event collector will collect the event and enqueue that event into the event pipeline queue.

In some implementations, an event processor component of the sensor 205 (e.g., the event processor 220) dequeues the event captured by the event collector from the event pipeline and processes it. When an event is processed in the container tracking stage of the event pipeline, the container tracking processor can perform the following operations. (1) Extract cgroup information from the event under processing; (2) Check the container tracking table if there is an entry for this cgroup (that is, the container is already running); (3) If an entry is found, associate container context with the event and return (that is, the event will be processed by the next stage in the pipeline); (4) If no entry is found in the container tracking table, use container API to collect all required information about the container using cgroup. Add all the collected information in the container tracking table; (5) If the cgroup information does not belong to a container, then return (that is, the event will be processed by the next stage in the pipeline); (6) Create a handcrafted container start event and return that event to the next processing stage in the event pipeline; (7) At the end of the pipeline, the container start event is sent, for example, to the cloud server 270 via the rules engine 260 using DRE protobuf.

An example start discovery workflow is described as below. In some implementations, when a sensor is started/enabled, it starts the process discovery workflow and generates events for each discovered process (i.e., a running process). Container discovery can be done in the context of the process discovery workflow. In some implementations, the container discovery workflow can use the same event processing steps as the container start event reporting workflow. In the container discovery workflow, a container discovery event will be sent in place of a container start event for each discovered container. A container start event is created and reported when a container is started. Container discovery events are created and reported for already running containers after the start of the sensor.

In some implementations, as an alternate approach, container enumeration can be done at sensor start time using container APIs. Information for all containers will be collected using container APIs. Based on the collected information, container discovery events can be generated and sent for each running container to the cloud server 270.

An example container stop workflow is described as below. In some implementations, when a container is stopped, the following sequence of events happens: all processes running inside the container get stopped; and the base process of the container is stopped.

In some implementations, the event collector obtains an exit event when a process gets terminated or exited through the installed hooks 215. In case of a container stop, the event collector gets an exit event for the base process and the event collector enqueues the exist event into the event pipeline queue. The container tracking processor 240 of the event pipeline can check the container tracking table 242 if there is an entry for the PID (e.g., the base process PID) for which the exit event is received. If there is such an entry, the container tracking processor 240 enqueues the current event in the front end of the event pipeline queue after setting the processor field to the next processing stage in the pipeline. A handcrafted container stop event can be created and returned to the next processing stage in the event pipeline. The entry for this PID and the corresponding container can be removed or otherwise marked as removed or terminated from the container tracking table 242. At the end of the pipeline, the container stop event is sent, for example, to the cloud server 270 via the rules engine 260 using DRE protobuf.

In some implementations, container security can be provided or improved. In some implementations, the security feature interacts with local container runtimes only. APIs provided by local container runtimes can be used to provide the security feature. In some implementations, local container runtimes use gRPC over Unix Domain Socket (UDS) to interact with local container engines with root privileges. The Linux sensor 205 can be configured by the user to use the appropriate path of UDS.

In some implementations, publicly exposed CBCAPIs can be accessed. Authorization check can be done at individual ENDPOINT level by using demand API calls. In some implementations, container APIs are invoked only at the container start time to extract attributes and the attributes are cached till the time when the container is running so no API will be invoked during processing of events generated by a containerized workload.

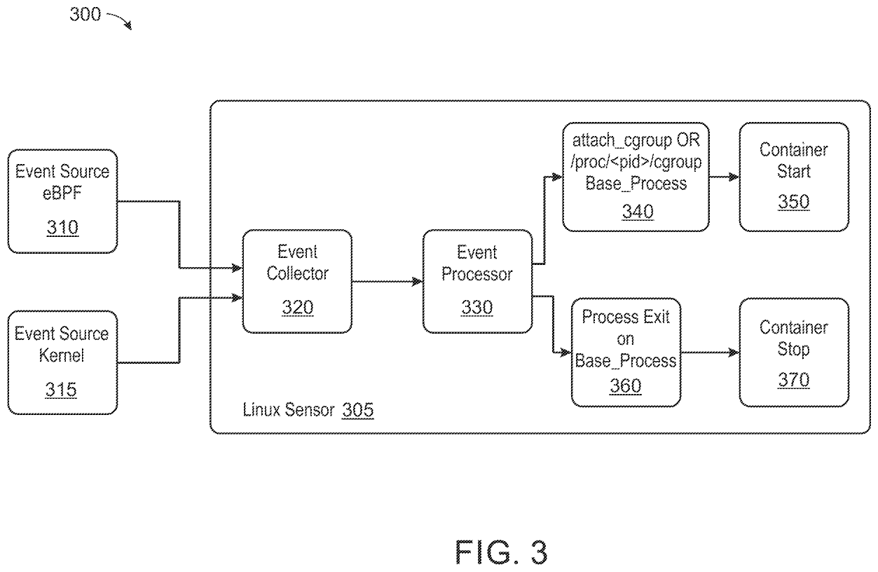

FIG. 3 is a schematic diagram illustrating an example flow 300 for creating container events, in accordance with example implementations of this specification. The example method can be implemented by a sensor 305 in a host device. The sensor 305 can be implemented, for example, by the sensor 205 in FIG. 2. In some implementations, the sensor 305 runs inside a VM, a physical machine, an endpoint, or a container host. The sensor 305 can be referred to as an agent, an engine, or module implemented by software or a combination of software and hardware. The sensor 305 gathers event data on the endpoint and securely delivers it to a server (e.g., a CB endpoint detection and response (EDR) server) for storage and indexing. The sensor 305 provides data from the endpoint to a cloud server (e.g., CBC analytics) for analyses.

In some implementations, the sensor 305 includes two components: an event collector 320 and an event processor 330. The event collector 320 collects events happening in a container host device, for example, using one or more kernel hooks/eBPF probes (e.g., the hooks 215 in FIG. 2). The event collector 320 has ability to capture events happening inside a container without putting any footprint inside the container. In some implementations, the event collector 320 can be implemented by the event collector 210, or a combination of the event collector 210 and at least part of the process tracking processor 230.

In some implementations, after capturing events, the event collector 320 can put events inside an event processor queue. The event processor 330 processes the events placed in the event processor queue by the event collector 320. The event processor 330 maintains a container lookup table which contains running container information. The event processor 330 populates the tables based on events that the event processor 330 obtains from the event collector 320. In some implementations, the event processor 330 can be implemented by the event processor 220 that includes the container tracking processor 240 and the container tracking processor 240, or a combination of at least part of the process tracking processor 230, the container tracking processor 240, the rules engine rules engine 260, and other components of the event processor 220.

The sensor 305 can use both two components, the event collector 320 and the event processor 330, to send container start/stop event to the cloud server so that the cloud server can add/remove container to a container inventory.

An example workflow for generating and sending a container start event 350 is described as below. The event collector 320 captures, for example, some or all the events happening in a container host device. If a container is started, a container entry process (e.g., the base process or the first container process) will start. The event collector 320 can collect the process starting event and enqueue that the process starting event into the event processor queue. The event processor 330 dequeues the event captured by the event collector 320 and processes the event. In some implementations, the event processor 330 checks whether the event belongs to a container, for example, using “/prod/<pid>/cgroup” command as shown in 340. If the event belongs to a container, the event processor 330 checks if a PID of the event is in a container lookup table. If the PID of the event is not in the container lookup table, the event processor 330 collects all required information (e.g., process, capability, root path, hostname, mounts, cgroupsPath, resources, IP, network, memory, namespace, environment variable, annotations), creates and sends a container start event 350 to the cloud server and includes the container information and process PID information in the container lookup table. If the PID of the event is in the container lookup table, the event processor 330 does not send container start information to the cloud server.

In another example work flow for generating and sending a container start event 350, an attach_cgroup system call can be used, as shown in 340. The attach_cgroup system call can be executed when a process running outside is moved into a container identified by the cgroup. Such an event and then a corresponding base process can be identified by the sensor 305. A container start event can be generated based on the event. In some implementations, an attach_cgroup operation can be tracked in the event collector 320. The attach_cgroup operation call can be pushed to the event processor 330. If the attach_cgroup operation is a base process of a container, a container start event 350 is created, and sent to the cloud server.

An example workflow for sending a container stop event 370 is described as below. The event collector 320 captures, for example, some or all the events happening in a container host device. If a container is stopped, the base process of the container will be stopped or terminated. The event collector 320 will collect the terminating or exit events of all processes (e.g., because the event collector 320 does not have information about base process) and enqueue each exit event into the event processor queue. The event processor 330 dequeues the event captured by the event collector 320 and processes it. Based on a PID of the exit process, the event processor 330 can check the container lookup table to see if any entry exists for the PID. If there is an entry for the PID, the event processor 330 can send a container stop event 370 to the cloud server and remove the entry from the container lookup table, or mark the container as being terminated or stopped. Based on the container stop event, the cloud server can remove the container from inventory, or mark the container as terminated or stopped.

As noted, the aforementioned approach does not require any integration with a container orchestration layer, nor does it require any integration with any container technology. The described techniques are container technology/management layer agnostic solutions to simplify container visibility and security manageability.

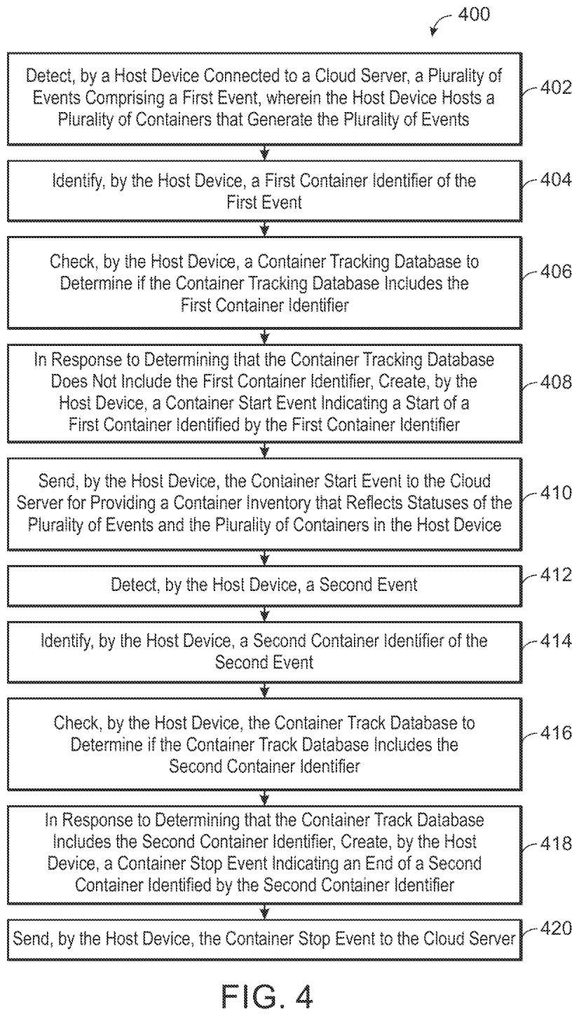

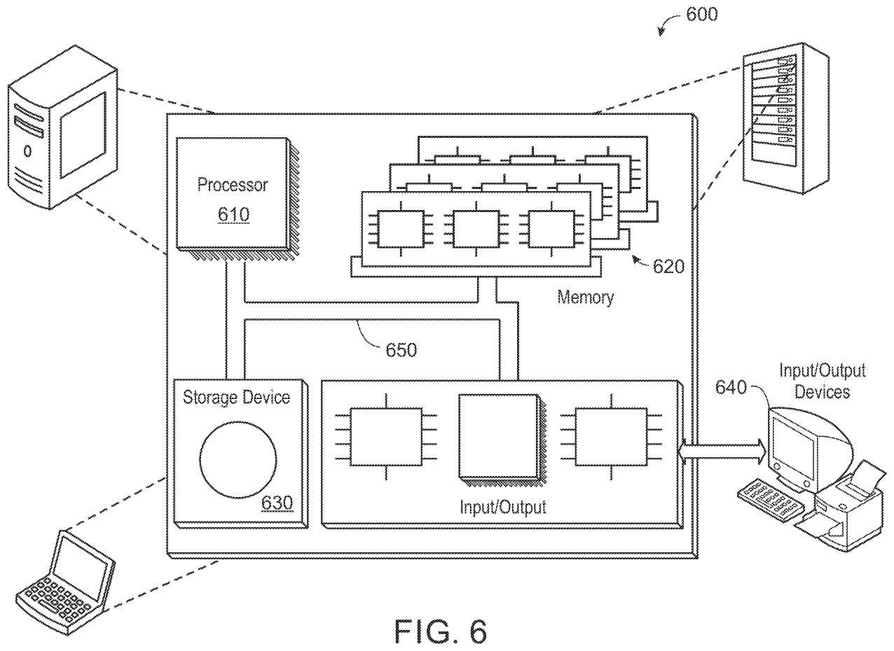

FIG. 4 illustrates a flowchart illustrating an example method 400 for providing container visibility and observability, in accordance with example implementations of this specification. In some implementations, the example method 400 can be performed, for example, according to techniques described w.r.t. FIGS. 2 and 3. The example method can be implemented by a data processing apparatus, a computer-implemented system, or a computing environment (referred to as a computing system) such as a computing system 100, 200, 600 as shown in FIGS. 1, 2, and 6. In some implementations, a computing system can be a system of one or more computers, located in one or more locations, and programmed appropriately in accordance with this disclosure. For example, a computing system 600 in FIG. 6, appropriately programmed, can perform the example process 400. In some implementations, the example method 400 can be implemented on Digital Signal Processor (DSP), Field Programmable Gate Array (FPGA), processor, controller, or a hardware semiconductor chip, etc.

In some implementations, the example process 400 shown in FIG. 4 can be modified or reconfigured to include additional, fewer, or different operations, which can be performed in the order shown or in a different order. In some instances, one or more of the operations can be repeated or iterated, for example, until a terminating condition is reached. In some implementations, one or more of the individual operations shown in FIG. 4 can be executed as multiple separate operations, or one or more subsets of the operations shown in FIG. 4 can be combined and executed as a single operation.

At 402, a plurality of events comprising a first event are detected, for example, by a host device (e.g., the host device 100) connected to a cloud server (e.g., the cloud server 270). The host device can include a sensor (e.g., the sensor 132 or Linux sensor 205) that further includes an event collector (e.g., the event collector 210 or 320) and an event processor (e.g., the event processor 220 or 330). In some implementations, the event processor (e.g., the event processor 220 or 330)can include or be implemented by one or more of a process tracking processor (e.g., the process tracking processor 230), a container tracking processor (e.g., the container tracking processor 240), a rules engine (e.g., rules engine 260) or a combination of these and other components.

The host device hosts a plurality of containers (or container instances) that generate the plurality of events. In some implementations, the plurality of containers are deployed, for example, to run workloads. In some implementations, the plurality of containers can be running on one or more virtual computing instances (VCIs) such as VMs that are connected to logical overlay networks that may span multiple hosts and are decoupled from the underlying physical network infrastructure. Though certain embodiments are described herein with respect to VMs, it should be noted that the teachings herein may also apply to other types of VCIs. In some implementations, the plurality of containers can be running on one or more physical machines, rather than VMs.

In some implementations, the plurality of containers are of different container types based on Kubernetes, ECS, Docker, or other types of container environments or implementations. The example process 400 is agnostic to specific implementation container types or implementations. The example process 400 can be applied universally to all types of container implementations and support host devices that hosts different types of containers.

At 404, a first container identifier of the first event is identified, for example, by the host device according to techniques described w.r.t. FIGS. 2 and 3. For example, the first container identifier of the first event can be identified by the process tracking processor of the sensor of the host device. In some implementations, identifying, by the host device, a first container identifier of the first event comprises identifying, by the host device, the first container identifier of the first event based on cgroup information of the first event, for example, according to techniques described w.r.t. FIGS. 2 and 3.

At 406, a container tracking database is checked, for example, by the host device, to determine if the container tracking database includes the first container identifier. For example, the first container identifier of the first event is identified by the container tracking processor of the sensor of the host device. In some implementations, the container tracking database can be a container tracking table (e.g., the container tracking table 242 in FIG. 2) or of another data structure.

In some implementations, the host device maintains the container tracking database, for example, by creating and updating the container tracking database. For example, in response to determining that the container tracking database does not include the first container identifier, the host device adds the first container into the container tracking database.

At 408, in response to determining that the container tracking database does not include the first container identifier, a container start event indicating a start of a first container identified by the first container identifier is created, for example, by the host device.

At 410, the container start event is sent to the cloud server, for example, by the host device, for providing a container inventory that reflects statuses of the plurality of events and the plurality of containers in the host device. In some implementations, the cloud server creates the container inventory and provides container visibility to an end-user (e.g., an operator or an administrator) using the container inventory.

At 412, a second event is detected, for example, by the host device according to techniques described w.r.t. FIGS. 2 and 3. The second event is can be one of the plurality of events detected at 402, or can be another event. In some implementations, the second event comprise an exit event of a base process of the second container.

At 414, a second container identifier of the second event is identified, for example, by the host device according to techniques described w.r.t. FIGS. 2 and 3. In some implementations, identifying, by the host device, a second container identifier of the second event includes, identifying, by the host device, the second container identifier of the first event based on cgroup information of the second event.

At 416, the container tracking database is checked, for example, by the host device to determine if the container tracking database includes the second container identifier.

At 418, in response to determining that the tracking database includes the second container identifier, a container stop event indicating an end of a second container identified by the second container identifier is created, for example, by the host device.

In some implementations, the host device maintains the container tracking database, for example, by in response to determining that the container tracking database includes the second container identifier, the host device deletes the second container identified by the second container identifier from the container tracking database.

At 420, the container stop event is sent, for example, by the host device, to the cloud server. In some implementations, the cloud server provides the container inventory can update the container inventory based on the container stop event to reflect, for example, the status of the second container in the host device. For example, the container stop event can be added to the container inventory and the status of the second container can be updated to be a stopped or ended status. In some implementations, in response to determine that the second container is in a stopped or ended status, the second container can be deleted from the container inventory, archived or otherwise marked by the cloud server to reflect the status of the second container in the host device. In some implementations, the cloud server provides the updated container inventory to provide container visibility to an end-user (e.g., an operator or an administrator), for example, in real time, on demand, periodically, from time to time, or in another manner.

In some implementations, after 420, the example method 400 can go back to 402 to identify a third event. In some implementations, multiple events can be identified in parallel or simultaneously. In some implementations, the second event can be identified before or at the same time of the first event.

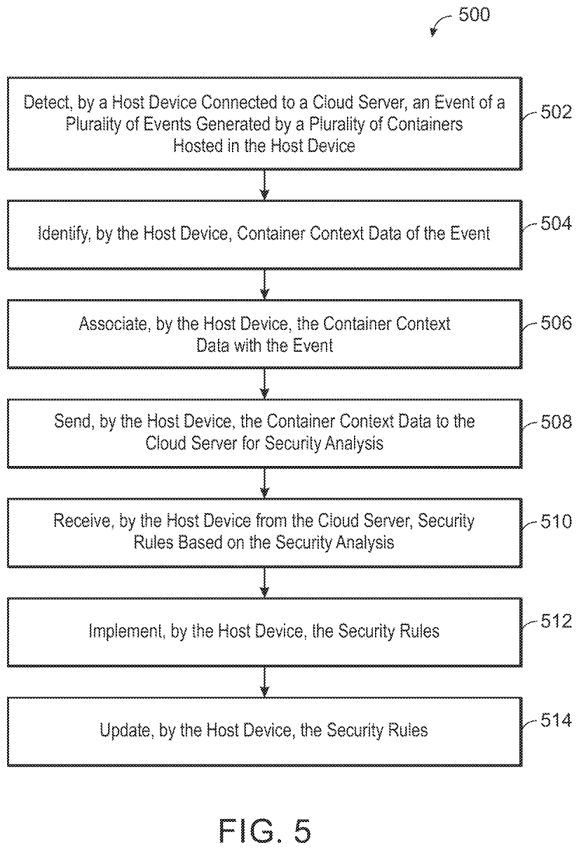

FIG. 5 illustrates a flowchart illustrating an example method 500 for providing container security manageability, in accordance with example implementations of this specification. In some implementations, the example method 400 can be performed, for example, according to techniques described w.r.t. FIGS. 2 and 3. The example method can be implemented by a computing system such as a computing system 100, 200, 600 as shown in FIGS. 1, 2, and 6. In some implementations, a computing system can be a system of one or more computers, located in one or more locations, and programmed appropriately in accordance with this disclosure. For example, a computing system 600 in FIG. 6, appropriately programmed, can perform the example process 500. In some implementations, the example method 500 can be implemented on Digital Signal Processor (DSP), Field Programmable Gate Array (FPGA), processor, controller, or a hardware semiconductor chip, etc.

In some implementations, the example process 500 shown in FIG. 5 can be modified or reconfigured to include additional, fewer, or different operations, which can be performed in the order shown or in a different order. In some instances, one or more of the operations can be repeated or iterated, for example, until a terminating condition is reached. In some implementations, one or more of the individual operations shown in FIG. 5 can be executed as multiple separate operations, or one or more subsets of the operations shown in FIG. 5 can be combined and executed as a single operation.

At 502, an event of a plurality of events is detected, for example, by a host device (e.g., the host device 100 or 205) connected to a cloud server (e.g., the cloud server 270). The plurality of events are generated by the host device. In some implementations, the host device hosts a plurality of containers that generate the plurality of events. In some implementations, the plurality of containers are deployed, for example, by a user (e.g., an administrator) where security of the containers are ensured by SecOps and SOC operators. SecOps and SOC operators use generally cloud based antivirus software such as CB to secure the plurality of containers and the host device of the plurality of containers.

At 504, container context data of the event are identified, for example, by the host device. In some implementations, the container context data of the event comprise one or more of a container identifier, a container IP address, a container root path, a hash of a root path, a hash of a process content (e.g., an executable/binary), a process path (e.g., a process path that is visible in the container), a process identifier (e.g., a process ID that is visible in the container), a container host name, or a container base image.

At 506, the container context data are associated with the event, for example, by the host device. In some implementations, the container context data are associated with the event according to techniques described w.r.t. FIG. 2. For example, the protobuf can be enhanced to associate container context with events originated from the process running in the container. In some implementations, a new rules engine target object can be created in the protobuf to represent a container. Along with new rules engine object for a container, a new set of actions/operations can be created to represent container events.

At 508, the container context data are sent, for example, by the host device, to the cloud server for security analysis. In some implementations, the cloud server provides the container context data to a user (e.g., an operator) for security analysis, for example, by presenting the information of the container context data in a graphic user interface (GUI) or in a textual format. In some implementations, the cloud server receives an input from the user that specifies one or more security rules. The security rules can include one or more actions or remedies that the host device or the cloud server are recommended or configured to take in response to one or more conditions (e.g., security breaches) as identified based on the container context data. In some implementations, due to the inclusion of the container information, the security rules can be container specific. For example, the users can specify different rules for different containers, along more flexibility and manageability of the containers and their respective events.

At 510, security rules based on the security analysis are received, for example, by the host device from the cloud server. The security rules determined by the cloud server can be sent to the host device for implementations, for example, by a rules engine (e.g., the rules engine 260) of the host device. The rules engine can include rules or policies (e.g., conditions or criteria and corresponding responses or remedial decisions or actions) for managing containers. The rules can include container-specific rules due to the container information provided by the container context data. For example, the rules can be different for different containers. In some implementations, the rules can be predetermined or specified by a security research team of users. In some implementations, the rules can be configured and updated by users. In some implementations, the rules can be updated or modified based on machine learning algorithms based on historic data of the container information and corresponding responses or remedial decisions or actions.

At 512, the security rules are implemented, for example, by the host device. In some implementations, the security rules are implemented, for example, by the rules engine the host device according to the example techniques described w.r.t. FIG. 2. In some implementations, implementing the security rules includes determining one or more conditions as specified in the security rules are satisfied and taking one or more actions or remedies corresponding to the conditions based on the determination. For example, if the container context data of the event include a container IP address, implementing the security rules can include quarantining a container based on an IP address of the container. In some implementations, if the container context data of the event include a container identifier, implementing the security rules can include blocking a container identified by the container identifier. In some implementations, if the container context data of the event comprise a root path of an event, a container identifier, a hash of a process content (e.g., binary/executable) that originated the event, implementing the security rules can include blocking a container based on the hash of the process content and the container identifier.

FIG. 6 is a schematic diagram illustrating an example computing system 600. The computing system 600 can be used for the operations described in association with the implementations described herein. For example, the computing system 600 may be included in any or all of the components discussed herein. The computing system 600 includes a processor 610, a memory 620, a storage device 630, and an input/output device 640. The components 610, 620, 630, and 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

Certain aspects of the subject matter described here can be implemented as a computer-implemented method. In some implementations, the method includes detecting, by a host device connected to a cloud server, a plurality of events comprising a first event, wherein the host device hosts a plurality of containers that generate the plurality of events; identifying, by the host device, a first container identifier of the first event; checking, by the host device, a container tracking database to determine if the container tracking database includes the first container identifier; in response to determining that the container tracking database does not include the first container identifier, creating, by the host device, a container start event indicating a start of a first container identified by the first container identifier; and sending, by the host device, the container start event to the cloud server for providing a container inventory that reflects statuses of the plurality of events and the plurality of containers in the host device.

An aspect taken alone or combinable with any other aspect includes the following features. The computer-implemented method further includes detecting, by the host device, a second event; identifying, by the host device, a second container identifier of the second event; checking, by the host device, the container tracking database to determine if the container tracking database includes the second container identifier; in response to determining that the container tracking database includes the second container identifier, creating, by the host device, a container stop event indicating an end of a second container identified by the second container identifier; and sending, by the host device, the container stop event to the cloud server.

An aspect taken alone or combinable with any other aspect includes the following features. The second event includes an exit event of a base process of the second container.

An aspect taken alone or combinable with any other aspect includes the following features. The computer-implemented method further includes maintaining, by the host device, the container tracking database by: in response to determining that the container tracking database does not include the first container identifier, adding the first container into the container tracking database; and in response to determining that the container tracking database includes the second container identifier, deleting the second container identified by the second container identifier from the container tracking database.

An aspect taken alone or combinable with any other aspect includes the following features. The plurality of containers are of different container types.

An aspect taken alone or combinable with any other aspect includes the following features. The the cloud server creates the container inventory and provides container visibility to an end-user using the container inventory.

An aspect taken alone or combinable with any other aspect includes the following features. The identifying, by the host device, a first container identifier of the first event includes identifying, by the host device, the first container identifier of the first event based on cgroup information of the first event.

Certain aspects of the subject matter described in this disclosure can be implemented as a non-transitory computer-readable medium storing instructions which, when executed by a hardware-based processor perform operations including the methods described here.

Certain aspects of the subject matter described in this disclosure can be implemented as a computer-implemented system that includes one or more processors including a hardware-based processor, and a memory storage including a non-transitory computer-readable medium storing instructions which, when executed by the one or more processors performs operations including the methods described here.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method operations can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a cathode ray tube (CRT) or liquid crystal display (LCD) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other operations may be provided, or operations may be eliminated, from the described flows, and other components may be added to, or removed from, the described systems. Accordingly, other implementations are within the scope of the following claims.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer-implemented method, comprising:
detecting, by a host device connected to a cloud server, a plurality of events comprising a first event, wherein the host device hosts a plurality of containers that generate the plurality of events;
identifying, by the host device, a first container identifier of the first event;
checking, by the host device, a container tracking database to determine if the container tracking database includes the first container identifier;
in response to determining that the container tracking database does not include the first container identifier, creating, by the host device, a container start event indicating a start of a first container identified by the first container identifier; and
sending, by the host device, the container start event to the cloud server for providing a container inventory that reflects statuses of the plurality of events and the plurality of containers in the host device.

2. The computer-implemented method of claim 1, further comprising:
detecting, by the host device, a second event;
identifying, by the host device, a second container identifier of the second event;
checking, by the host device, the container tracking database to determine if the container tracking database includes the second container identifier;
in response to determining that the container tracking database includes the second container identifier, creating, by the host device, a container stop event indicating an end of a second container identified by the second container identifier; and
sending, by the host device, the container stop event to the cloud server.

3. The computer-implemented method of claim 2, wherein the second event comprises an exit event of a base process of the second container.

4. The computer-implemented method of claim 2, further comprising:
maintaining, by the host device, the container tracking database by:
in response to determining that the container tracking database does not include the first container identifier, adding the first container into the container tracking database; and
in response to determining that the container tracking database includes the second container identifier, deleting the second container identified by the second container identifier from the container tracking database.

5. The computer-implemented method of claim 1, wherein the plurality of containers are of different container types.

6. The computer-implemented method of claim 1, wherein the cloud server creates the container inventory and provides container visibility to an end-user using the container inventory.

7. The computer-implemented method of claim 1, wherein identifying, by the host device, a first container identifier of the first event comprises identifying, by the host device, the first container identifier of the first event based on cgroup information of the first event.

8. A non-transitory, computer-readable medium storing one or more instructions executable by a host device connected to a cloud server to perform operations, the operations comprising:
detecting, by the host device, a plurality of events comprising a first event, wherein the host device hosts a plurality of containers that generate the plurality of events;
identifying, by the host device, a first container identifier of the first event;
checking, by the host device, a container tracking database to determine if the container tracking database includes the first container identifier;
in response to determining that the container tracking database does not include the first container identifier, creating, by the host device, a container start event indicating a start of a first container identified by the first container identifier; and
sending, by the host device, the container start event to the cloud server for providing a container inventory that reflects statuses of the plurality of events and the plurality of containers in the host device.

9. The non-transitory, computer-readable medium of claim 8, the operations further comprising:
detecting, by the host device, a second event;
identifying, by the host device, a second container identifier of the second event;
checking, by the host device, the container tracking database to determine if the container tracking database includes the second container identifier;
in response to determining that the container tracking database includes the second container identifier, creating, by the host device, a container stop event indicating an end of a second container identified by the second container identifier; and
sending, by the host device, the container stop event to the cloud server.

10. The non-transitory, computer-readable medium of claim 9, wherein the second event comprises an exit event of a base process of the second container.

11. The non-transitory, computer-readable medium of claim 9, the operations further comprising:
maintaining, by the host device, the container tracking database by:
in response to determining that the container tracking database does not include the first container identifier, adding the first container into the container tracking database; and
in response to determining that the container tracking database includes the second container identifier, deleting the second container identified by the second container identifier from the container tracking database.

12. The non-transitory, computer-readable medium of claim 8, wherein the plurality of containers are of different container types.

13. The non-transitory, computer-readable medium of claim 8, wherein the cloud server creates the container inventory and provides container visibility to an end-user using the container inventory.

14. The non-transitory, computer-readable medium of claim 8, wherein identifying, by the host device, a first container identifier of the first event comprises identifying, by the host device, the first container identifier of the first event based on cgroup information of the first event.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, the one or more operations comprising:
detecting, by a host device connected to a cloud server, a plurality of events comprising a first event, wherein the host device hosts a plurality of containers that generate the plurality of events;
identifying, by the host device, a first container identifier of the first event;
checking, by the host device, a container tracking database to determine if the container tracking database includes the first container identifier;
in response to determining that the container tracking database does not include the first container identifier, creating, by the host device, a container start event indicating a start of a first container identified by the first container identifier; and
sending, by the host device, the container start event to the cloud server for providing a container inventory that reflects statuses of the plurality of events and the plurality of containers in the host device.

16. The computer-implemented system of claim 15, the one or more operations further comprising:
detecting, by the host device, a second event;
identifying, by the host device, a second container identifier of the second event;
checking, by the host device, the container tracking database to determine if the container tracking database includes the second container identifier;
in response to determining that the container tracking database includes the second container identifier, creating, by the host device, a container stop event indicating an end of a second container identified by the second container identifier; and
sending, by the host device, the container stop event to the cloud server.

17. The computer-implemented system of claim 16, wherein the second event comprises an exit event of a base process of the second container, and the one or more operations further comprise:
maintaining, by the host device, the container tracking database by:
in response to determining that the container tracking database does not include the first container identifier, adding the first container into the container tracking database; and
in response to determining that the container tracking database includes the second container identifier, deleting the second container identified by the second container identifier from the container tracking database.

18. The computer-implemented system of claim 15, wherein the plurality of containers are of different container types.

19. The computer-implemented system of claim 15, wherein the cloud server creates the container inventory and provides container visibility to an end-user using the container inventory.

20. The computer-implemented system of claim 15, wherein identifying, by the host device, a first container identifier of the first event comprises identifying, by the host device, the first container identifier of the first event based on cgroup information of the first event.
